(19) United States
(12) Patent Application Publication
(10) Pub. No.: US 2004/0254322 A1
(43) Pub. Date: Dec. 16, 2004

(54) Easily torn charged or uncharged films and methods and compositions for producing same

(76) Inventors: John S. Trent, Kenosha, WI (US); James L. Oberholtzer JR., Midland, MI (US); James C. Pawloski, Bay City, MI (US); Julie M. Grissmeyer, Waterford, WI (US); Jose Porchia, Greenfield, WI (US)

Correspondence Address: S.C. JOHNSON & SON, INC., 1525 HOWE STREET, RACINE, WI, 53403-2236, US

(21) Appl. No.: 10/458,096

(22) Filed: Jun. 10, 2003

(51) Int. Cl. B32B 27/12

(52) U.S. Cl. 526/348.1; 526/351; 442/41; 524/451

(57) ABSTRACT

A polymer film comprises a composition having either a polyolefin or a polyamide as a major component. The film has an Elmendorf tear value parameter of about 200 g/mil or less, a thickness greater than about 0.5 mils. The film has a melt flow index between at least about 2 g/10 min. and less than about 17 g/10 min. and further includes a filler to achieve the 200 g/mil tear value parameter. Alternatively, the film has a melt flow index of at least about 17 g/10 min and need not include a filler. The film is substantially unstretched in the transverse direction. The film may be charged. A method of producing a film is also disclosed.

### TECHNICAL FIELD

The present invention relates generally to films, and more particularly to films that are substantially unstretched in the transverse direction and methods of manufacture thereof.

### BACKGROUND ART

There are many potential uses for a web or sheet of film material. Such materials might be used to protect a surface and/or one or more items that may be disposed thereon. For example, film material could be used to line shelves, drawers, and other surfaces. The material may be adhesive-backed. The material could also be used as a placemat or as a table covering.

Another example of the use of a web or sheet is as a protective covering on other, larger structures, such as a dropcloth on a floor or a liner in a trunk of a car or on a bed of a truck. These products typically must be sufficiently durable to withstand foot traffic and/or other forms of abuse, although less durable materials (e.g., paper) may be used as temporary protective coverings.

Mix U.S. Pat. No. 1,151,895 discloses a sanitary kneading board wherein a quantity of parchment paper is unwound from a roll and placed atop the board to completely cover the surface thereof. Similar arrangements are disclosed in Johnson U.S. Pat. No. 1,952,375 and Hoel U.S. Pat. No. 2,369,898, although wax paper is used instead of parchment paper in the latter.

Pollock U.S. Pat. No. 5,193,793 discloses a mixing board wherein a plurality of stacked plastic sheets are disposed on a top surface thereof. Each of the plastic sheets has a backing of pressure sensitive adhesive binding the sheets together. A user may mix a compound on a top sheet and may thereafter peel off the top sheet and dispose of same so that a clean surface is provided for subsequent use.

A number of arrangements have been developed wherein an electrostatically charged sheet is used to secure an article to a surface. For example, Henley U.S. Pat. No. 5,970,638 discloses a transparent electrostatic vinyl sheet and a cover film wherein an object, such as a dried and pressed flower, is tightly sealed between the vinyl sheet and the cover film to create a sealed ornament. The sealed ornament may be applied to a non-porous surface and the electrostatic film maintains the ornament in position thereon. Other arrangements utilizing electrostatic sheets to mount objects are disclosed in Arbisi U.S. Pat. No. 5,826,851, Baryla U.S. Pat. No. 4,741,119, Saetre U.S. Pat. No. 5,102,171, and Rubino U.S. Pat. No. 4,992,121.

Peck U.S. Pat. No. 5,899,010 discloses a reusable banner system including a sheet of plastic material and a plurality of flexible static cling vinyl indicia that may be placed on the sheet of plastic material to form a message. The indicia are maintained in position on the sheet of plastic material by the electrostatic charge carried by the indicia. In an alternate embodiment, the sheet of plastic material carries an electrostatic charge and the indicia are made of non-porous plastic.

Stonehouse U.S. Pat. No. 5,010,671 discloses a flip chart comprising at least two sheets disposed in overlying relationship. The sheets are electrically charged and are releasably securable to a surface by static cling. The sheets are adapted for removable marking thereon by a felt pen and are retained on a backing board by staples. Each sheet may be torn from the staples to permit removal of the sheet from the flip chart.

Boyd U.S. Pat. No. 5,207,581 discloses a writing apparatus including flexible electret film that is capable of being erasably written upon by a dry erase marker. The apparatus includes a roll of electret film disposed in a receptacle, brackets for mounting the receptacle to a wall or flip chart stand and a cutter for separating the film into sheets.

Cooledge et al. U.S. Pat. No. 5,258,214 discloses a thermoplastic film material having a preprinted image thereon and provided with a static electrical charge for securing the film to a surface. The material may be packaged as sheets or in roll form with perforations to permit separation thereof.

Some films may be difficult to tear with ordinary cutting instruments and have a tendency to stretch rather than tear in response to a shearing force. While it might be possible to easily tear such films with a very sharp instrument, overly sharp instruments might prove impractical for ordinary use. However, one approach to this problem is disclosed in Kamp U.S. Pat. No. 4,426,029, which employs a unique cutting bar disposed on a container containing stretchable film. The cutting bar resembles the type one would find on a box of aluminum foil or plastic wrap. A sheet of the stretchable film is drawn from within the container and pulled downward on the cutting bar. The cutting bar includes a plurality of blunt projections or ridges each disposed between sharp teeth. The projections are of greater height than the teeth. When the sheet of film is pulled over the cutting bar, the film stretches upon the projections before contacting the sharp teeth. The teeth do not pierce the stretchable sheet until the projections have first stretched the sheet, essentially taking the stretch out of the sheet, to allow for uniform tearing.

Another method of facilitating the tearing of a film is called orienting, which involves stretching of a film during manufacture. Orienting essentially prestretches a film to make the film more easily cut or torn by a cutting instrument. Orienting may be performed in one or two directions. For example, orienting may be done monoaxially (i.e., stretching along the machine direction only) or biaxially (i.e., stretching in both the machine direction and the cross or transverse direction). Erickson U.S. Pat. No. 4,885,352 discloses oriented olefinic films that have good cutter bar tear. These oriented films are disclosed as having a melt index of between about 1 decigram/minute to about 6 decigrams/minute. Melt flow index (or “MFI”) is a measure of the melt viscosity of the polymer, which in turn is related to the molecular weight. Melt flow index is expressed as a mass, in grams, of a material extruded per 10 minute period under a constant dead weight load and at a constant temperature wherein the load and temperature are specified by ASTM D-1238 for the particular material being tested.

While orienting is generally known to be effective in producing a film capable of being easily torn, orienting may require the use of stretching apparatus, which can add to manufacturing cost. Therefore, providing a film capable of being easily torn without the need for stretching is advantageous.

### SUMMARY OF THE INVENTION

In accordance with one aspect of the present invention, a polymer film includes a polyolefin as a major component. The film has a melt flow index between at least about 2 g/10 min. and less than about 17 g/10 min. and a thickness greater than about 0.5 mils. The film has an Elmendorf tear value parameter in a transverse direction of about 200 g/mil or less. An effective amount of a filler is provided to achieve the tear value parameter given that the film is substantially unstretched in the transverse direction.

In accordance with a further aspect of the present invention, a polymer film includes a polyolefin as a major component and has a melt flow index of at least about 17 g/10 min and a thickness greater than about 0.5 mils. The film has an Elmendorf tear value parameter in a transverse direction of about 200 g/mil or less. The film film is substantially unstretched in the transverse direction.

Another aspect of the present invention comprehends a polymer film that has a polyamide as a major component, a melt flow of at least about 2 g/10 min., and a thickness greater than about 0.5 mils. The film has an Elmendorf tear value parameter in a transverse direction of about 200 g/mil or less. The film is substantially unstretched in the transverse direction.

In accordance with a still further aspect of the present invention, a method of producing a polymer film having an Elmendorf tear value parameter in a transverse direction of about 200 g/mil or less, includes the step of selecting a polymer composition having a polypropylene as a major component. The composition has a melt flow index of between about 2 g/10 min. and less than about 17 g/10 min. An effective amount of a filler is added to the composition. The composition is formed into a film greater than about 0.5 mils thick. The film achieves the tear value parameter without the need for substantial stretching in a transverse direction.

A further aspect of the present invention comprehends a method of producing a polymer film having an Elmendorf tear value parameter in a transverse direction of about 200 g/mil or less. The method includes the step of selecting a polymer composition having a polypropylene as a major component and a melt flow index of at least about 17 g/10 min. The composition is formed into a film greater than about 0.5 mils thick. The film achieves the tear value parameter without the need for substantial stretching in the transverse direction.

A further aspect of the present invention comprehends a method of producing a charged film. The method includes the steps of forming a film from a composition, placing first and second charging stations adjacent the film, and charging the film with the first and second charging stations.

Other aspects and advantages of the present invention will become apparent upon consideration of the following detailed description.

### BRIEF DESCRIPTION OF THE DRAWINGS

FIG. 1 is an isometric view illustrating a roll of film disposed within a container;

FIG. 2 is a fragmentary isometric view of a drawer lined by a sheet of film;

FIG. 3 is an isometric view of a bookcase having shelves that are lined by a sheet of film;

FIG. 4 is an elevational view of a sheet of film used as a writing surface;

FIG. 5 is a bar chart illustrating Elmendorf values of various films;

FIG. 6 is a bar chart illustrating Puncture-Propagation-Tear test values of various films;

FIG. 7 is a diagrammatic view of apparatus associated with a prior art casting process;

FIG. 8 is a diagrammatic cross sectional view of a prior art placement of both an extrusion die and an air knife relative to a cast roll;

FIG. 9 is a diagrammatic cross sectional view, according to the present invention, of a placement of an extrusion die and air knife relative to a cast roll; and

FIGS. 10 and 11 are diagrammatic elevational and isometric views, respectively, of apparatus downstream of the chill roll that charge the film and cut the film into sections;

### DESCRIPTION OF THE PREFERRED EMBODIMENTS

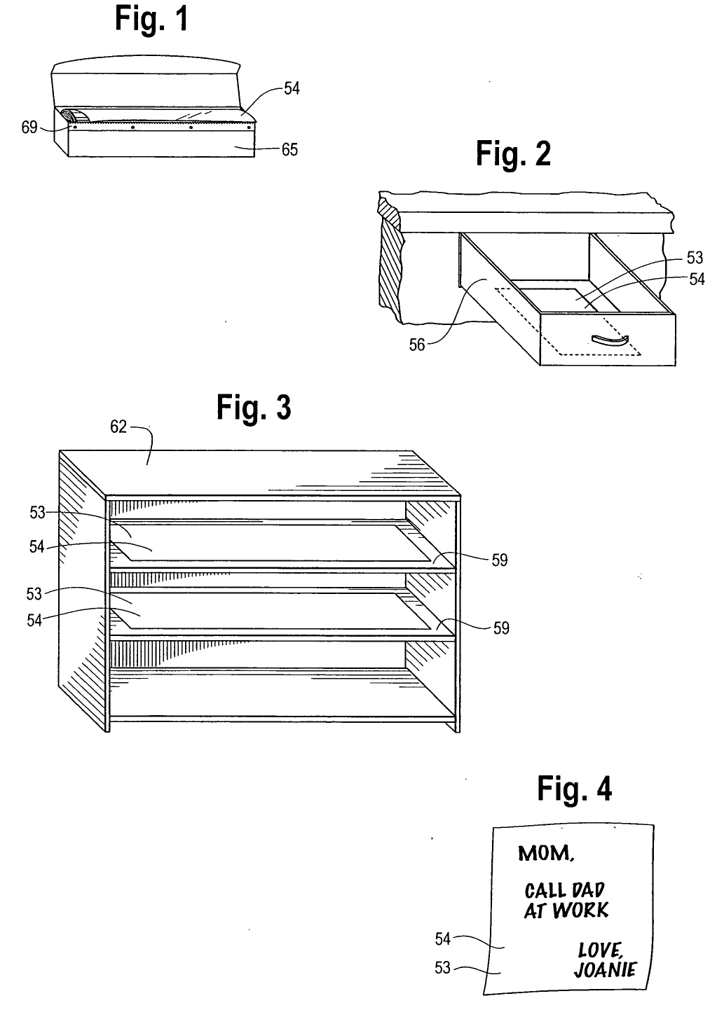

Films produced according to the present invention may be used for a vast variety of potential uses. For example, a sheet 53 of a film 54 may be used to line a drawer 56 (FIG. 2), to line shelves 59 of a bookcase 62 (FIG. 3), to function as a writing surface (FIG. 4), to function as a placemat (not shown) or as a surface for processing food products (not shown) thereon, or for a variety of other purposes. These and other varieties of uses of film are taught in greater detail in co-pending U.S. patent applications Ser. Nos. 09/948,642; 09/948,543; 09/948,211; 09/948,212; 09/948,532; 09/948,643; and 09/948,644; all filed on Sep. 7, 2001, and all herein incorporated by reference. The film 54 could be electrostatically charged (in a manner discussed hereinafter) so that the sheet 53 may detachably affix to any of the surfaces 56, 59, or a variety of other surfaces (not shown) such as a wall, a glass surface such as a window or mirror, a refrigerator, a floor, a wooden deck surface, etc. In this regard, a charged film disposed on such surfaces is electrostatically attracted to the surface, thereby inhibiting movement of the film relative to the surface. This might allow a user to write on the film or position objects thereon without moving or substantially moving the film. While the film 54 may be stored in any suitable manner, FIG. 1 shows that the film 54 might be rolled up and disposed within a cardboard container 65 having a conventional saw-toothed cutting bar 69. A user may tear off a portion of the film 54 to create a sheet, such as the sheet 53, by pulling the film 54 downwardly on the cutting bar 69. One test for quantifying ease of tearing is the Elmendorf tear test described in ASTM 1922. The Elmendorf test measures the energy required to propagate a tear in a film. A film having an Elmendorf tear value parameter in the transverse direction (TD) of about 200 grams of force per mil or less is considered herein as preferable in terms of being easily torn on a cutting bar. Increasingly more preferable tear value parameters (TD) include: about 150 g/mil or less; about 100 g/mil or less; and about 50 g/mil or less (most preferred). It should be noted that Elmendorf tear values depend in part on film thickness. A film twice as thick as an otherwise identical film is about twice as hard to tear, and thus has typically twice the Elmendorf tear value. Films according to the present invention are greater than about 0.5 mils thick and may be as thick as about 3 mils or even much thicker. More preferably, the film thickness is between about 0.75 mils and about 3 mils. Most preferably, the films are between about 1 mil and about 2 mils thick.

Films according to the present invention may be of a first or a second formula to achieve one or more of the above tear value parameters. The first formula comprises as a major component either of a polyolefin or a polyamide, a melt flow index between about 2 g/10 min. and less than about 17 g/10 min., and an effective amount of a filler. Suitable polyolefins include polyethylenes, polypropylenes, or suitable blends or copolymers thereof. If the major component is a polypropylene, the polypropylene may be a polypropylene homopolymer available from Atofina Petrochemical of Houston, Tex., as shown in the Examples provided hereinbelow. Suitable polyamides include nylons such as nylon 6, nylon 6-6, nylon 11, nylon 12, or other suitable polyamides. It should be noted that polypropylenes may be preferred over polyethylenes as the major component because polypropylenes have a higher modulus and greater durability. Durability is potentially desirable for various uses of films described above in connection with FIGS. 1-4.

The filler may be any suitable filler such as minerals of calcium carbonate, barite, mica and wollastonite, as well as glass spheres and fibers or organic fillers such as wood, flour, nutshells, or flax. The filler may be a nucleating agent such as carboxylic acid salts, benzyl sorbitols, and salts of organic phosphates. However, talc particles are a highly preferred nucleating agent, and talc particles about 1.7 μm in size are even more highly preferred. It should be noted, that talc particles greater than 3 μm may adversely affect film surface appearance, feel, and color. While many sources of talc are available, Cimpact 71 OHS coated talc particles sold by Luzenac America of Englewood, Colo., may be used.

The second formula comprises as a major component either a polyolefin or a polyamide of any of the above-described types, a melt flow index of about 17 g/10 min. or more, and may optionally include a filler (discussed hereinbelow). The filler is optional and is not required to achieve the 200 g/mil parameter. It should be noted, however, that a filler may desirably be included anyway because the filler promotes a clean edge when the film is torn.

Where a filler or other components are incorporated, it is critical to sufficiently mix/compound same to uniformly distribute the components throughout the composition. This is accomplished by using appropriate compounding described hereinafter. In this regard, insufficient compounding of the components could potentially preclude successful or optimal creation of film, resulting in a film of very poor, commercially unacceptable quality. For example, an inadequately compounded film may exhibit pinholes and localized weak spots.

In the course of experimenting with various film compositions, it was surprising to achieve good quality films from increasingly high MFI compositions such as 40 g/10 min. to 350 g/10 min. It was also surprising to cast the films of the invention because the example polymers used, all available from Atofina Petrochemical, were intended for producing fibers rather than film. Successful production was unexpected because it was believed that such high MFI compositions, which tend to have a highly watery consistency, would not be able to generate sufficient back pressure to push the melt through the die and produce a uniform web. It was very surprising to successfully cast a polypropylene film of 350 g/10 min. (It is believed that this film probably bad an Elmendorf tear value (TD) of between about 5 to about 15 g/mil.) A problem encountered with this extremely high melt flow film was that it was overly susceptible to tearing during manufacture when pulled by various rollers such as those seen in FIG. 11, thereby increasing the difficulty of manufacturing. The film would frequently break resulting in excessive downtime to restring the film through rollers. However, films of 100 g/10 min. were successfully produced with less downtime than the 350 g/10 min. film. It should be noted that an adjustable lip push-pull die may be used for film production. Such dies have die lip adjustment bolts that pull the die lip away from the film material when retracted (“pulled” up) rather than relying on the back pressure of the film material to push on the die lip. This may be particularly advantageous for a high melt flow film that generates only a small amount of back pressure. Such dies are known in the art and are available from Extrusion Dies Industries of Chippewa Falls, Wis.

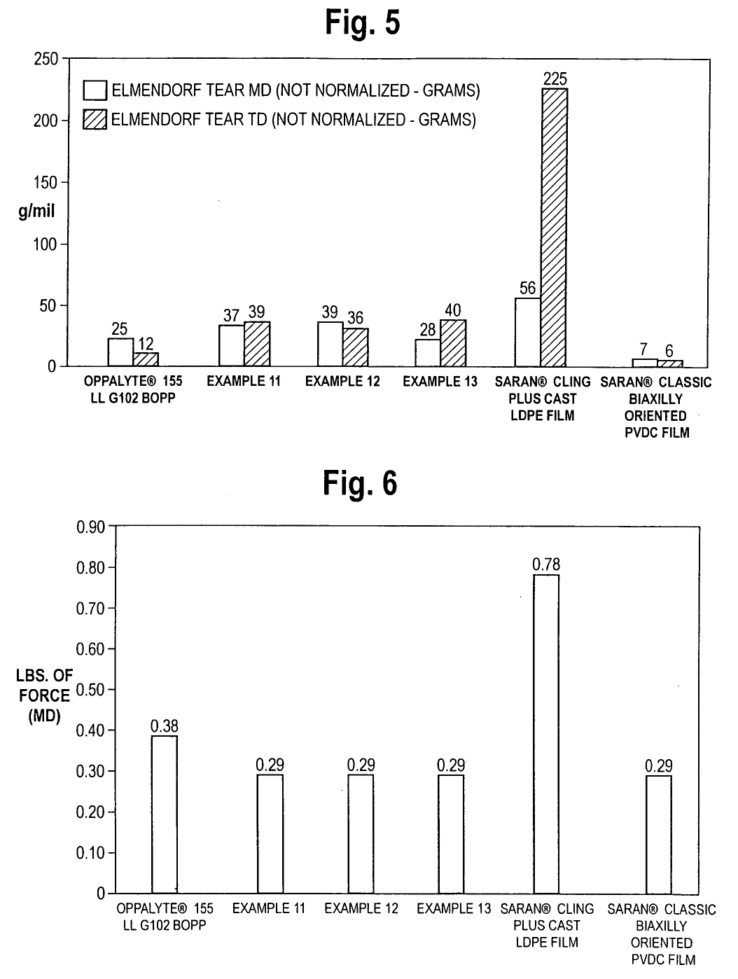

Without wishing to be bound by theory, it is believed that unoriented films having an MFI less than about 2 g/10 min. that are thicker than 0.5 mils generally would not achieve the 200 g/mil (TD) parameter. However, films about 0.5 mils or thinner might achieve the 200 g/mil parameter. Samples of Saran® Cling Plus Cast LDPE (low density polyethylene) film (FIG. 5), available from S.C. Johnson & Son, Inc. of Racine, Wis., have a thickness of 0.5 mils, a melt flow index of about 2.0 to about 2.5 g/10 min., and are not stretched in the transverse direction. These film samples exhibit a tear value (TD) of 225 g/mil, a value approaching the about 200 g/mil or less parameter. Decreasing the thickness of this Saran® film sufficiently below 0.5 mils should likely result in a film having a tear value within the about 200 g/10 min. or less parameter.

Referring to FIG. 5, two known films that are stretched in the transverse direction, and which form no part of the present invention, are OPPALYTE® 155LLG102 BOPP (FIG. 5), a multilayered polypropylene film available from ExxonMobil Corporation of Macedon, N.Y. and Sarang Classic, a blown biaxially oriented film of polyvinylidene chloride (PVDC) also available from S.C. Johnson & Son, Inc. Both of these films are considered biaxially oriented. The OPPALYTE® and Saran® Classic films exhibit tear values (TD) of 12 g/mil and 6 g/mil, respectively, as a result of having been stretched in the transverse direction. FIGS. 5 and 6 compare Examples 12, 13, and 14 films to the Oppalyte® and Saran® films. The formulas of Examples 12-14 are provided hereinbelow.

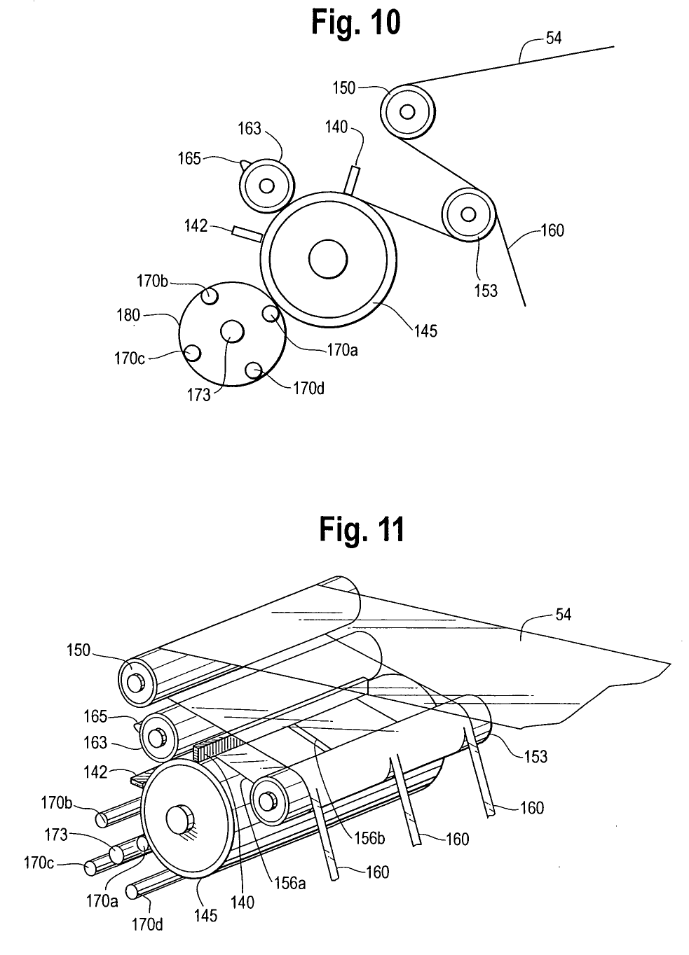

Stretching in the machine direction is not believed to have any appreciable affect on ease of tearing in the transverse direction. Also, stretching in the machine direction is not considered particularly important because such stretching might not necessarily involve any great expense or difficulty. In fact, stretching in the machine direction can occur merely by the pulling of the film along a chill roll 75 (FIG. 9) or by other various rollers (FIGS. 10, 11), whether intentionally or unintentionally. Accordingly, the present invention encompasses films that are either unstretched or stretched in the machine direction.

Another test used to compare the severability of film is called the Puncture-Propagation-Tear (PPT) Test, conducted in accordance with ASTM D 2582. While it may be somewhat instructive to view PPT test results for films, as seen in FIG. 6, the Elmendorf tear value (TD) is probably a more helpful gauge of tearing ease than PPT values. A high PPT value generally reflects a film that is difficult to tear. The test measures the combined effects of puncture and tear. The length of the tear is a measure of the energy absorbed by the film sample in stopping a carriage and spike (not shown), which move through the film. So, the PPT test is the determination of how well a film resists tearing. FIG. 6 compares the PPT values among the films of FIG. 5.

The composition may further include a coloring agent such as titanium dioxide, which produces a white color. Other suitable coloring agents may be added, in addition to or in substitution of the titanium dioxide, to produce desired shades of yellow, blue, purple, etc. A more complete description of pigments and dyes to produce color in resin can be found in Polypropylene: The Definitive User's Guide and Databook, Clive Maier & Teresa Calafut, Plastics Design Library, Norwich, N.Y. 1998, incorporated herein by reference. If titanium dioxide is added as the sole coloring agent, it may be added in an amount up to about 20% (by weight), depending on the desired translucency of the film and/or the amount of filler.

Stabilization of the composition is important for inhibiting oxidative degradation during compounding and film formation processes. If unstabilized, this oxidation could result in undesirably changing the MFI of the film composition. Therefore, primary antioxidants such as hindered phenolics (Alvinox FB or Iraganox 3114) and secondary antioxidants such as aromatic amines, phosphites (Alvinox P or Irgaphos 168), or thioesters (Alvipak 122) may be added to inhibit or prevent such oxidation and any change in MFI associated therewith. Alvinox P and FB are sold by 3V, Inc. of Weehawken, N.Y. Iraganox 3114, Irgaphos 168 and Alvipak 122 are sold by Ciba Specialty Chemicals of Tarrytown, N.Y.

A color correcting pigment may be added to the composition, if desired, to counter any color changing affects produced by one or more constituents of the composition. For example, the use of talc as a nucleating agent might cause some yellowing of the resulting film. Any suitable color correcting pigment(s) (toner) may be added to counter such a color altering affect. CEY 5022A Ultramarine Blue Concentrate, sold by Holliday Pigments located at Morley Street, Kingston upon Hull, N. Humberside, HU8 8DN, England, may be added to the composition as needed to produce a film of uniform white color.

As noted above, all components of the composition are uniformly distributed throughout the composition so that the resulting film is of uniform strength (without locations of varying strength) appearance, and texture. Uniform distribution of all components is important to produce a film having a uniform color, smooth texture, and glossy surface. It should be noted that uniform distribution of the filler or nucleating agent allows one to use a smaller amount of filler or nucleating agent while still achieving desired film properties. Localized weak spots are not conducive to uniform severing because some regions of the film would stretch while other regions would tear and the film may tear in a direction transverse to the cutting bar 69 (FIG. 1) rather than tearing parallel thereto. Also, localized weak spots could cause tearing during manufacture as the film is pulled along various rollers. Uniform distribution coloring compounds (e.g., titanium dioxide) inhibits localized spots of differing hue.

If desired, the film may be electrostatically charged so that the film retains a charge. The film should preferably exhibit an electric field strength of at least approximately 1000 Volts/meter or more. More preferably, the film should retain this charge for at least three or more months following charging of the film. The manner of charging the film is discussed hereinafter.

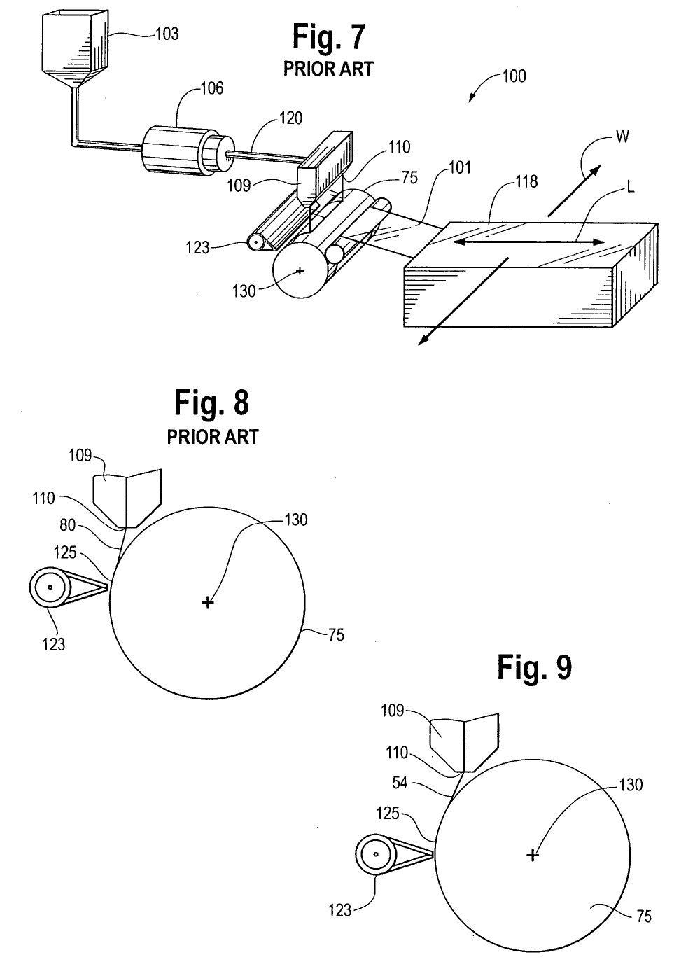

FIG. 7 illustrates, in diagrammatic fashion, known extrusion casting apparatus 100 used to create a biaxially oriented film 101. A hopper 103 is supplied with thermoplastic pellets (not shown) made of a composition comprising a thermoplastic polymer along with any additional components such as antioxidants and/or pigments. Typical biaxially oriented films incorporate resins having an MFI between about 2 g/10 min. to about 12 g/10 min. or slightly higher. The pellets of composition are fed to an extruder 106. The extruder 106 melts the composition and delivers the resulting molten material, within a suitable range of temperatures, to a slot die 109. A flat sheet of the resulting film 101 exits an outlet 110 of the die 109. The flat sheet of film 101 cools and crystallizes (i.e., solidifies) upon exiting the die 109. The film 101 is further cooled by the chill roll 75 onto which the film 101 is deposited.

In a blown film operation, the film is biaxially oriented during the blowing process. However, in the illustrated cast film process, the film 101 travels to a stretching apparatus 118 that stretches the film 101 along both a longitudinal axis L (i.e., the machine direction) and a transverse axis W, thereby taking the stretch out of the film 101 to make the film 101 capable of being more easily torn. The film 101, upon exiting the chill roll 75, might pass between a pair of opposed calendar rollers (not shown) that compress the film 101 therebetween to stretch and thin the film 101. The stretching apparatus 118 may include any combination of driven and non-driven rollers (not shown) designed to move at different speeds and thereby purposefully stretch the film 101 in the machine direction along the longitudinal axis L. The stretching apparatus 118 also includes any known gripping or clamping devices (not shown) disposed on each side of the film 101 to stretch the film 101 along the axis W. For example, tenter frames (not shown but well known in the art) may be used to stretch films in the transverse direction. A more complete description of the biaxial orientation process can be found in Polypropylene: The Definitive User's Guide and Databook, Clive Maier & Teresa Calafut, Plastics Design Library, Norwich, N.Y. 1998.

A method of making films of the invention may comprise creating pellets of a polymer composition wherein such pellets are supplied to a hopper such as the hopper 103. These pellets might be stored for a period of time or used almost immediately to form the film 54. As discussed previously, if a filler or other components are included in the polymer composition, these are uniformly distributed throughout the composition. While the components may be distributed in any suitable manner, the components are suitably distributed by a twin screw extruder. It should be noted that compounding all components as described herein allowed creation of acceptable films using only half the talc needed in the absence of such a compounding step. It is found that using a twin screw extruder, as opposed to a single screw extruder, is highly effective in uniformly distributing all components of the composition. After being compounded within the twin screw extruder, the resulting pellets are then dried for a suitable period of time. Drying the pellets can be important for successfully casting good quality film.

Sometime after the pellets have dried and it is desired to use the pellets to make the film 54, the pellets are fed to a six inch (15.24 cm) single screw extruder analogous to the extruder 106. This extruder is preferably equipped with a 24:1 length to diameter ratio, chrome-plated DSBM (Davis-Standard Barrier Screw with Maddock Mixer) feed screw sold by Davis-Standard of Pawcatuck, Conn. The feed screw is specifically designed for the polymer composition. The single screw extruder may develop any suitable melt temperature such as between about 204° C. and about 209° C. However, the melt temperature might be higher or lower depending on the composition. In this regard, a melt temperature should be developed that is sufficient to melt down the pellets of composition, but the melt temperature should not be so high to degrade the composition beyond the protective ability of the antioxidants incorporated in the composition. The single screw extruder may employ any suitable head pressure, screw rotation speed, and cast speed. For example, for a 100 g/10 min. composition the head pressure was set between about 1250 to about 1400 pounds per square inch (about 8.6 to about 9.6 MPa). The screw speed was set at about 94 revolutions per minute, and the cast speed was about 260 feet (79.2 m) per minute. It should be noted however, that any of the above settings for the single screw extruder may be modified depending principally on melt temperature and slight differences in Theological (i.e., flow) properties among possible compositions used to make the film. It is important that the temperature of the molten thermoplastic downstream of the extruder 106 is suitably lower than in the extruder so that there is an adequate pressure differential between the extruder 106 and the die 109 to drive the film making process. In this regard, it may be necessary to provide one or more transfer lines 120 (FIG. 7) with cooling apparatus to maintain a suitable melt temperature therein. The die 109 may also incorporate temperature regulation apparatus (e.g., thermostatically controlled heaters and the like) to maintain a suitable temperature. Preferably, a melt temperature of 195° (90.5° C.) is maintained in the one or more lines 120 (FIG. 7) and in the die 109.

A high melt flow film (e.g., 40 g/10 min.) may tend to be very liquid exiting the die outlet 110 such that rapid cooling of the film is desired. Referring to FIG. 9, placing the chill roll 75 close to the die outlet 110 speeds cooling of the film. In a conventional arrangement shown in FIG. 8, the chill roll 75 is not as close to the outlet 110. By placing the outlet 110 as close to the roll 75 as possible, the film 54 is able to contact the cool surface of the roll 75, thereby speeding the rate of solidification of the film 54. The chill roll 75 is preferably placed within less than about 8 inches from the die outlet and, may be placed within about 2 to about 6 inches from the outlet. An airknife 123 may be provided adjacent the chill roll. The airknife 123 is preferably placed sufficiently below a tangent point 125, which is the initial point of contact of the film on the chill roll 75, so that the film 54 has had sufficient time to cool and solidify before receiving a blast of air from the airknife 123. As seen in FIG. 9, the airknife 123 is more preferably placed slightly downstream of a center axis of rotation 130 of the chill roll 75, which is lower than in the conventional arrangement shown in FIG. 8. The air knife 123 continuously blows air onto the film 54 at a sufficient pressure to press the film 54 uniformly to the surface of the chill roll 75, and thereby prevent formation of wrinkles, clumps, or other irregularities in the film 54. It was found that a pressure of about 5 inches of water (1.25 kPa) was suitable. However, other higher or lower pressures might also be suitable. The chill roll 75 is preferably chilled to an 18° C. set point, thereby maintaining a surface temperature of the chill roll 75 within a range of between about 16° to about 20° C.

As discussed previously, an electrostatic charge may be supplied to the film 54. The charge may be negative or positive, but is preferably positive. The charge supplied to the film 54 should be sufficient so that the film 54 retains a charge sufficient to exhibit at least approximately 1000 Volts/meter or more three or more months following charging. Of course, other greater or lesser amounts of charge retention may be desired. The charge may be supplied by one or more charging stations. For example, as seen in FIGS. 10 and 11, the charge may be supplied to the film by first and second charging stations 140 and 142, respectively. While any suitable charging station may be used, the charging stations 140, 142 are preferably charging bars of a type marketed as CHARGEMASTER, sold by Simco Industrial Static Control of Hatfield, Pa. It should be noted that using the two charging stations 140, 142 of intermediate voltage, rather than a single charging station (not shown) of greater voltage, was found to be more effective in creating a film that retains a charge for a long duration. It should be noted that the use of charging stations, such as two or more charging stations may be useful for any type of film. In addition, the charged films processed by the charging stations 140, 142 were found to have a sufficient affinity for ink or other marking compounds without the need for additional corona-type treatment beyond the use of the charging stations 140, 142. The charging stations 140, 142 are grounded to a bed roll 145 in any suitable manner. For example, a wire (not shown) may extend from each of the charging stations 140, 142 to a control box (not shown) that is grounded to the bed roll 145 by a similar wire (not shown). The control box controls voltage of the charging stations 140, 142 or any other features (e.g., speed of the bed roll 145).

While the charging station 140 or 142 may supply any suitable charge, the charge supplied may range between about 10 to about 50 kilovolts. The charging station 140 or 142 may be spaced any suitable distance from the film 54 such as between about 0.25 inches to about 3 inches from the film. It should be noted that the spacing of the charging stations 140, 142 and the amount of charge supplied therefrom may be varied depending upon ambient humidity. Generally, a more humid environment may tend to make the film 54 surface moister as well as the airspace between the film 54 and the charging stations 140, 142. This ambient water may tend to absorb or conduct charge away from the film 54, thereby requiring closer placement of and/or increased charge from the charging stations 140, 142. The first charging station 140 preferably supplies a charge between about 25 to about 35 kilovolts, and is preferably spaced about 1.5 inches from the film. The second charging station preferably supplies a charge between about 20 kilovolts to about 50 kilovolts, and more preferably the second charge is about 25 kilovolts and is spaced about 1 inch (2.54 cm) from the film.

While FIGS. 10 and 11 illustrate apparatus downstream of the apparatus shown in FIG. 9, it should be noted that a second chill roll (not shown) similar or identical to the chill roll 75 is preferably provided immediately downstream of the chill roll 75 and upstream of the apparatus shown in FIGS. 10 and 11. As with the chill roll 75, this second chill roll (not shown) is preferably driven. Upon leaving such second chill roll, the film 54 is directed over a first guide roller 150 and then a second guide roller 153. Grounding brushes (not shown but well known in the art) may be provided in contact with the sides of the various rollers to inhibit accumulation of static charge. A plurality of blades (not shown) cut the film 54 in the machine direction into two or more sections 156a, 156b as the film 54 is guided over the roller 153. The film 54 may be cut into any number of desired sections depending on manufacturing preferences, and may preferably be cut into six sections. The sections 156 may be of any desirable width such as 11.75 inches (29.8 cm) wide. It should be noted that films of the present invention may tend to have relatively low Elmendorf tear values in the machine direction (as seen in FIG. 5), which facilitates easy cutting of the film 54 into the sections 156. Cutting of the film 54 into the sections 156 creates trim scrap, shown diagrammatically at 160. This trim scrap 160 may be collected and recycled back into film production in any suitable manner. It should be noted that in addition to supplying charge to the film 54, the charging station 140 also electrostatically pins the sections 156 of the film 54 against the bed roll 145, so that the film 54 does not lift off the roll 145 when the blades cut the film 54 into the sections 156. A chopping roller 163 is provided immediately downstream of the charging station 140 to cut the sections 156 in the transverse direction to create long sheets of the film 54 that may be rolled up and disposed in a box such as the box 65 (FIG. 1). The chopping roller 163 carries a blade 165 along the longitudinal dimension thereof. The chopping roller 163 may be rotated at an appropriate speed to achieve the desired length given the size of the chopping roller 163. Alternatively, the chopping roller 163 may be rotated in an intermittent fashion. As a still further alternative, the chopping roller 163 might not rotate or roll at all and may simply move toward or away from the sections 156 of film to effect cutting. The second charging station 142 is provided downstream of the chopping roller.

The long sections 156 are rolled up in any suitable manner such as by use of mandrels 170a-d. A shaft 173 and the mandrels 170 are fixed at one end to a support 180 (seen only in FIG. 10). The shaft 173 is rotated in an intermittent manner, thereby turning the support 180, and thus the mandrels 170, in a clockwise direction. Long hollow cores (not shown) of cardboard, or other suitable material, are loaded onto each of the mandrels 170 when in the position shown at 170c. When each of the mandrels 170 is in the position shown at 170b, the long core is cut to a plurality of shorter cores of suitable length to accommodate an individual section of the sections 156. When at the position shown at 170a, a belt (not shown) engages the mandrel 170, thereby rotating the mandrel for winding each of the sections 156 onto each of the cores. At the position shown at 170d, the loaded cores are ejected and conveyed by suitable means to downstream packaging equipment. The rolls of film are ultimately disposed within a suitable container, such as the container 65 (FIG. 1). A user may draw the film 54 across the conventional cutting bar 69 to tear off a sheet of the film 54 into a desired length.

### EXAMPLES

Examples 1-6 designate first formula examples, while Examples 7-13 designate second formula examples.

### Example 1

9 MFI Atofina Film

| Percent by Weight | Chemical Name | Commercial Name |
|---|---|---|
| 79.775 | Hompolymer | (FINA 3571) (9 MFI) |
| | Polypropylene | |
| 10.000 | about 1.7 μm Coated | Cimpact 710HS |
| | china talc particles | |
| 0.015 | Blue pigment | CEY 5022A Blue |
| | | Conc. |
| 10.000 | Coated titanium | Ti-Pure R104 TiO₂ |
| | dioxide | |
| 0.050 | 1,3,5-Triazine-2,4,6 | Alvinox FB |
| | (1H, 3H, 5H)-trione, | |
| | 1,3,5-tris[[3,5-bis-(1,1- | |
| | dimethyl)-4- | |
| | hydroxyphenyl]methyl] | |
| 0.160 | Phenol 2,4-bis (1,1- | Alvinox P |
| | dimethylethyl),- | |
| | phosphite (3:1) | |

A 1.7 mil thick film was made with the above formula and exhibited a tear value (TD) of 33 g/mil. The films were produced with equipment described above. The films were extruded from a slot die at 220° C. onto a chill roll at an 18° C. setpoint at a rate of 350 feet/minute.

Other films of the formulas specified in the remaining examples were produced in a like manner to Example 1. With regard to each of the following examples, unless specified otherwise, a 200 gram weight was used to obtain tear values for films made with the formula of each example.

### Example 2

9 MFI Atofina film

| Percent by Weight | Chemical Name | Commercial Name |
|---|---|---|
| 100.00 | Homopolymer | (FINA 3571) (9 |
| | Polypropylene | MFI) |

A 1.5 mil thick film was made with the above formula and exhibited a tear value (TD) of 23.8 g/mil. Regarding Examples 1 and 2, films made with these formulas were found to be highly suitable in terms of both ease of tearing and ease of pellet formation. These films had an MFI of 9 g/10 min and were considered potentially optimal overall in terms of tearing ease and ease of pellet formation. However, it should be noted that a slightly higher MFI and/or incorporation of additional talc could result in a film having more desirable tearing ease while still providing excellent ease of pellet formation.

### Comparative Example A

| Percent by | | Commercial | |
|---|---|---|---|
| Weight | Chemical Name | Name | MFI (g/10 min.) |
| 100 | Homopolymer | (FINA 3276) | 2 |
| | Polypropylene | | |

A film of 1.53 mils and a film of 1.66 mils were prepared with the above formula and exhibited Elmendorf tear values (TD) of 1646.10 g/mil and 1679.40 g/mil, respectively. A 3200 gram weight was used to obtain these tear values.

### Example 3

7 MFI Atofina Film

| Percent by Weight | Chemical Name | Commercial Name |
|---|---|---|
| 23.932 | Homopolymer | (FINA 3276) (2 MFI) |
| | Polypropylene | |
| 55.842 | Homopolymer | (FINA 3622) (12 MFI) |
| | Polypropylene | |
| 10.000 | about 1.7 μm Coated | Cimpact 710HS |
| | china talc particles | |
| 0.015 | Blue pigment | CEY 5022A |
| | | Concentrate |
| 10.000 | Coated titanium | Ti-Pure R104 TiO₂ |
| | dioxide | |
| 0.050 | 1,3,5-Triazine-2,4,6 | Alvinox FB |
| | (1H, 3H, 5H)-trione, | |
| | 1,3,5-tris[[3,5-bis-(1,1- | |
| | dimethyl)-4- | |
| | hydroxyphenyl]methyl] | |
| 0.160 | Phenol 2,4-bis (1,1- | Alvinox P |
| | dimethylethyl),- | |
| | phosphite (3:1) | |

A 1.5 mil film was made with the above formula and exhibited a tear value (TD) of 24.5 g/mil.

### Example 4

10 MFI Atofina Film

| Percent by Weight | Chemical Name | Commercial Name |
|---|---|---|
| 7.978 | Homopolymer | (FINA 3276) (2 MFI) |
| | Polypropylene | |
| 71.797 | Homopolymer | (FINA 3622) (12 MFI) |
| | Polypropylene | |
| 10.000 | about 1.7 μm Coated | Cimpact 710HS |
| | china talc particles | |
| 0.015 | Blue pigment | CEY 5022A |
| | | Concentrate |
| 10.000 | Coated titanium | Ti-Pure R104 TiO₂ |
| | dioxide | |
| 0.050 | 1,3,5-Triazine-2,4,6 | Alvinox FB |
| | (1H, 3H, 5H)-trione, | |
| | 1,3,5-tris[[3,5-bis-(1,1- | |
| | dimethyl)-4- | |
| | hydroxyphenyl]methyl] | |
| 0.160 | Phenol 2,4-bis (1,1- | Alvinox P |
| | dimethylethyl),- | |
| | phosphite (3:1) | |

A 1.5 mil film was made with the above formula and exhibited a tear value (TD) of 19.6 g/mil.

### Example 5

12 MFI Atofina Film

| Percent by Weight | Chemical Name | Commercial Name |
|---|---|---|
| 79.775 | Homopolymer | (FINA 3622) (12 MFI) |
| | Polypropylene | |
| 10.000 | about 1.7 μm Coated | Cimpact 710HS |
| | china talc particles | |
| 0.015 | Blue pigment | CEY 5022A |
| | | Concentrate |
| 10.000 | Coated titanium | Ti-Pure R104 TiO₂ |
| | dioxide | |
| 0.050 | 1,3,5-Triazine-2,4,6 | Alvinox FB |
| | (1H, 3H, 5H)-trione, | |
| | 1,3,5-tris[[3,5-bis-(1,1- | |
| | dimethyl)-4- | |
| | hydroxyphenyl]methyl] | |
| 0.160 | Phenol 2,4-bis (1,1- | Alvinox P |
| | dimethylethyl),- | |
| | phosphite (3:1) | |

A 1.6 mil film was made with the above formula and exhibited a tear value (TD) of 19.6 g/mil.

### Example 6

15 MFI Atofina Film

| Percent by Weight | Chemical Name | Commercial Name |
|---|---|---|
| 47.865 | Homopolymer | (FINA 3761) (18 MFI) |
| | Polypropylene | |
| 31.910 | Homopolymer | (FINA 3622) (12 MFI) |
| | Polypropylene | |
| 10.000 | about 1.7 μm Coated | Cimpact 710HS |
| | china talc particles | |
| 0.015 | Blue pigment | CEY 5022A |
| | | Concentrate |
| 10.000 | Coated titanium | Ti-Pure R104 TiO₂ |
| | dioxide | |
| 0.050 | 1,3,5-Triazine-2,4,6 | Alvinox FB |
| | (1H, 3H, 5H)-trione, | |
| | 1,3,5-tris[[3,5-bis-(1,1- | |
| | dimethyl)-4- | |
| | hydroxyphenyl]methyl] | |
| 0.160 | Phenol 2,4-bis (1,1- | Alvinox P |
| | dimethylethyl),- | |
| | phosphite (3:1) | |

A 1.5 mil film was made with the above formula and exhibited a tear value (TD) of 15.6 g/mil.

### Example 7

18 MFI Atofina film

| Percent by Weight | Chemical Name | Commercial Name |
|---|---|---|
| 100 | Homopolymer | FINA 3761 (18 MFI) |
| | Polypropylene | |

Films of 1.58 mil and 1.72 mil were made with the above formula and exhibited tear values (TD) of 164 g/mil and 111.90 g/mil, respectively. A 200 gm weight was used to obtain the tear value of the 1.58 mil film, while an 800 gram weight was used with the 1.72 mil film.

### Example 8

18-20 MFI Atofina film

| Percent by Weight | Chemical Name | Commercial Name |
|---|---|---|
| 100 | Homopolymer | (FINA 3720WZ) (18-20 |
| | Polypropylene | MFI) |

Films of 1.49 mil and 1.74 mil were made with the above formula and exhibited tear values (TD) of 105.50 g/mil and 124.20 g/mil, respectively.

### Example 9

60 MFI Atofina film

| Percent by Weight | Chemical Name | Commercial Name |
|---|---|---|
| 100 | Homopolymer | (FINA) 3925WZ (60 |
| | Polypropylene | MFI) |

Films of 1.46 mil and 1.60 mil were made with the above formula and exhibited tear values (TD) of 105.10 g/mil and 101.90 g/mil, respectively.

### Example 10

100 MFI Atofina Film

| Percent by Weight | Chemical Name | Commercial Name |
|---|---|---|
| 79.775 | Homopolymer | (FINA 3860X) (100 |
| | Polypropylene | MFI) |
| 10.000 | about 1.7 μm Coated | Cimpact 710HS |
| | china talc particles | |
| 0.015 | Blue pigment | CEY 5022A |
| | | Concentrate |
| 10.000 | Coated titanium | Ti-Pure R104 TiO₂ |
| | dioxide | |
| 0.050 | 1,3,5-Triazine-2,4,6 | Alvinox FB |
| | (1H, 3H, 5H)-trione, | |
| | 1,3,5-tris[[3,5-bis-(1,1- | |
| | dimethyl)-4- | |
| | hydroxyphenyl]methyl] | |
| 0.160 | Phenol 2,4-bis (1,1- | Alvinox P |
| | dimethylethyl),- | |
| | phosphite (3:1) | |

A 1.6 mil film and a 1.8 mil film were produced with the above formula and had tear values (TD) of 11.3 g/mil and 18.2 g/mil, respectively.

### Example 11

100 MFI Atofina Film

| Percent by Weight | Chemical Name | Commercial Name |
|---|---|---|
| 81.475 | Homopolymer | (FINA 3860X) (100 |
| | Polypropylene | MFI) |
| 8.000 | about 1.7 μm Coated | Cimpact 710HS |
| | china talc particles | |
| 10.000 | Coated titanium | Ti-Pure R104 TiO₂ |
| | dioxide | |
| 0.015 | Blue pigment | CEY 5022A |
| | | Concentrate |
| 0.050 | 1,3,5-Triazine-2,4,6 | Alvinox FB |
| | (1H, 3H, 5H)-trione, | |
| | 1,3,5-tris[[3,5-bis-(1,1- | |
| | dimethyl)-4- | |
| | hydroxyphenyl]methyl] | |
| 0.160 | Phenol 2,4-bis (1,1- | Alvinox P |
| | dimethylethyl),- | |
| | phosphite (3:1) | |
| 0.300 | Calcium Stearate | Calcium Stearate DK |

A 1.6 mil film was made with the above formula and had a tear value (TD) of 39 g/mil, respectively. Example 12 includes Calcium Stearate which inhibits sticking of pellets to each other during pellet formation. Of course, this or other stearates or other suitable lubricants could be incorporated in any of the film formulas disclosed herein.

### Example 12

100 MFI Atofina Film

| Percent by Weight | Chemical Name | Commercial Name |
|---|---|---|
| 79.475 | Homopolymer | (FINA 3860X) (100 |
| | Polypropylene | MFI) |
| 10.000 | about 1.7 μm Coated | Cimpact 710HS |
| | china talc particles | |
| 10.000 | Coated titanium dioxide | Ti-Pure R104 TiO₂ |
| 0.015 | Blue pigment | CEY 5022A |
| | | Concentrate |
| 0.050 | 1,3,5-Triazine-2,4,6 | Alvinox FB |
| | (1H, 3H, 5H)-trione, | |
| | 1,3,5-tris[[3,5-bis-(1,1- | |
| | dimethyl)-4- | |
| | hydroxyphenyl]methyl] | |
| 0.160 | Phenol 2,4-bis (1,1- | Alvinox P |
| | dimethylethyl),- | |
| | phosphite (3:1) | |
| 0.300 | Calcium Stearate | Calcium Stearate DK |

A 1.6 mil film was made with the above formula and had a tear value (TD) of 36 g/mil.

### Example 13

100 MFI Atofina Film

| Percent by Weight | Commercial Name |
|---|---|
| 100 | FINA 3860X (100 MFI) |

A 1.62 mil thick film and a 1.75 mil thick film were made with the above formula and these had tear values (TD) of 80.6 g/mil and 87.1 g/mil, respectively. A 200 gram weight was used to obtain these values. Another 1.6 mil film was made with the above example and had a tear value (TD) of 40 g/mil. The 1.6 mil and 1.62 mil films have somewhat different tear values. Of course, tear values can vary based on film casting process variations, age of film prior to testing, film thickness, rate of film production, melt temperature variations, or air cooling and chill roll temperature variations.

Examples 11-13 are shown in FIGS. 5 and 6 in comparison to the biaxially oriented Oppalyte® and the Sarang Classic film samples. As discussed above, the 1.6 mil films made with the formulas of Examples 11, 12, and 13 exhibited tear values (TD) of 39 g/mil, 36 g/mil, and 40 g/mil, respectively. These tear values are well within the about 50 g/mil or less tear value parameter and exhibit an ease of tearing on the cutting bar 69 similar to the Oppalyte® and the Saran® Classic film samples.

Empirical data suggest that for unfilled films: an MFI of at least about 20 g/10 min. would be sufficient to achieve the about 150 g/mil or less parameter; an MFI of at least about 40 g/10 min. would be sufficient to achieve the about 100 g/mil or less parameter; and an MFI of at least about 50 g/10 min. would be sufficient to achieve the about 50 g/mil or less parameter. Of course, it should be evident that filled films may require a lower MFI to achieve a given tear value parameter.

### INDUSTRIAL APPLICABILITY

The preceding embodiments are applicable to creating a film that may be easily torn without the need for stretching in the transverse direction. The concept of increasing the melt flow index of a film of a given thickness to achieve a desired Elmendorf tear value (TD) without the need to stretch the film is applicable to many species of polyolefins, polyamides, and equivalents thereof.

Numerous modifications to the present invention will be apparent to those skilled in the art in view of the foregoing description. Accordingly, this description is to be construed as only an exemplification of the claimed technology and is presented for the purpose of enabling those skilled in the art to make and use the invention and to teach the best mode of carrying out same. The exclusive rights to all modifications which come within the scope of the appended claims are reserved.

1. A polymer film, comprising:
a polyolefin as a major component;
a melt flow index between at least about 2 g/10 min. and less than about 17 g/10 min.;
a thickness greater than about 0.5 mils;
an Elmendorf tear value parameter in a transverse direction of about 200 g/mil or less; and
an effective amount of a filler to achieve the tear value parameter wherein the film is substantially unstretched in the transverse direction.

2. The film of claim 1, wherein the thickness is between about 0.75 and about 3 mils.

3. The film of claim 1, wherein the thickness is greater than 3 mils.

4. The film of claim 1, wherein the polyolefin comprises a polypropylene.

5. The film of claim 1, wherein the polyolefin comprises a polyethylene.

6. The film of claim 1, wherein the film has an Elmendorf tear value in the transverse direction of about 150 g/mil or less.

7. The film of claim 6, wherein the polyolefin comprises a polypropylene.

8. The film of claim 1, wherein the film has an Elmendorf tear value in the transverse direction of about 100 g/mil or less.

9. The film of claim 8, wherein the polyolefin comprises a polypropylene.

10. The film of claim 1, wherein the film has an Elmendorf tear value in the transverse direction of about 50 g/mil or less.

11. The film of claim 10, wherein the polyolefin comprises a polypropylene.

12. The film of claim 1, wherein the film has a PPT value of about 0.50 lbs. of force or less.

13. The film of claim 1, wherein the filler is a nucleating agent.

14. The film of claim 13, wherein the nucleating agent is talc.

15. The film of claim 1, wherein the film is easily torn by a cutting instrument.

16. The film of claim 15, wherein the cutting instrument is a cutting bar.

17. The film of claim 1, wherein the film is charged.

18. The film of claim 17, wherein the film exhibits a charge of at least approximately 1000 Volts/meter or more.

19. A polymer film, comprising:
a polyolefin as a major component;
a melt flow index of at least about 17 g/10 min.;
a thickness greater than about 0.5 mils; and
an Elmendorf tear value parameter in a transverse direction of about 200 g/mil or less;
wherein the film is substantially unstretched in the transverse direction.

20. The film of claim 19, wherein the thickness is between about 0.75 and about 3 mils.

21. The film of claim 19, wherein the polyolefin comprises a polypropylene.

22. The film of claim 19, wherein the polyolefin comprises a polyethylene.

23. The film of claim 19, wherein the film has an Elmendorf tear value in the transverse direction of about 150 g/mil.

24. The film of claim 23, wherein the film has a melt flow index of at least about 30 g/10 min.

25. The film of claim 24, wherein the polyolefin comprises a polypropylene.

26. The film of claim 19, wherein the film has an Elmendorf tear value in the transverse direction of about 100 g/mil or less.

27. The film of claim 26, wherein the melt flow index is at least about 40 g/10 min.

28. The film of claim 27, wherein the polyolefin comprises a polypropylene.

29. The film of claim 19, wherein the film has an Elmendorf tear value in the transverse direction of about 50 g/mil or less.

30. The film of claim 29, wherein the melt flow index is at least about 50 g/10 min.

31. The film of claim 30, wherein the polyolefin comprises a polypropylene.

32. The film of claim 19, wherein the film has a PPT value of about 0.50 lbs. of force or less.

33. The film of claim 19, further comprising a filler.

34. The film of claim 33, wherein the filler is a nucleating agent.

35. The film of claim 34, wherein the nucleating agent is talc.

36. The film of claim 19, wherein the film is charged.

37. The film of claim 36, wherein the film exhibits a charge of at least approximately 1000 Volts/meter or more.

38.-44. (Cancelled)

45. A method of producing a polymer film having an Elmendorf tear value parameter in a transverse direction of about 200 g/mil or less, the method comprising the steps of:
selecting a polymer composition having a polypropylene as a major component and having a melt flow index of between about 2 g/10 min. and less than about 17 g/10 min;
adding an effective amount of a filler to the composition; and
forming the composition into a film greater than about 0.5 mils thick;
wherein the film achieves the tear value parameter without the need for substantial stretching in a transverse direction.

46. The method of claim 45, further comprising the steps of providing a slot die having an outlet and providing apparatus downstream of the outlet for processing of the film.

47. The method of claim 45, wherein the thickness of the film formed is between about 0.75 and about 3 mils.

48. The method of claim 45, wherein the film has an Elmendorf tear value in the transverse direction of about 150 g/mil or less.

49. The method of claim 45, wherein the film has an Elmendorf tear value in the transverse direction of about 100 g/mil or less.

50. The method of claim 45, wherein the film has an Elmendorf tear value in the transverse direction of about 50 g/mil or less.

51. The method of claim 50, wherein the thickness is between about 1 to about 2 mils.

52. The method of claim 45, wherein the film has a PPT value of about 0.50 lbs. of force or less.

53. The method of claim 45, wherein the filler is a nucleating agent.

54. The method of claim 53, wherein the nucleating agent is talc.

55. The method of claim 45, further comprising compounding the composition with a twin screw extruder.

56. The method of claim 45, further comprising the step of severing the film into two or more sections.

57. The method of claim 45, further comprising the step of charging the film.

58. The method of claim 57, wherein the charging is supplied by one or more charging stations that supply a voltage between about 10 to about 50 kilovolts

59. The method of claim 58, wherein the charging is supplied by first and second charging stations.

60. The method of claim 59, wherein the charging stations are spaced between about 0.25 to about 3 inches from the film.

61. The method of claim 57, wherein the charge is negative.

62. The method of claim 57, wherein the charge is positive.

63. The method of claim 60, wherein the first charging station supplies between about 25 to about 35 kilovolts and is spaced about 1.5 inches from the film and wherein the second charging station supplies between about 20 kilovolts to about 50 kilovolts.

64. The method of claim 57, wherein the charge supplied to the film results in a film that retains sufficient charge to develop at least approximately 1000 Volts/meter or more at three months or more following charging.

65. The method of claim 45, further comprising the step of placing a chill roll within less than about 8 inches of the outlet.

66. The method of claim 65, wherein the chill roll is placed within about 2 to about 6 inches from the outlet.

67. The method of claim 65, wherein an airknife is positioned downstream of a center axis of rotation of the chill roll.

68. A method of producing a polymer film having an Elmendorf tear value parameter in a transverse direction of about 200 g/mil or less, the method comprising the steps of:
selecting a polymer composition having a polypropylene as a major component and having a melt flow index of at least about 17 g/10 min.;
forming the composition into a film greater than about 0.5 mils thick;
wherein the film achieves the tear value parameter without the need for substantial stretching in a transverse direction.

69. The method of claim 68, further comprising the step of adding an effective amount of a filler to the composition.

70. The method of claim 69, wherein the filler is talc.

71. The method of claim 68, further comprising the step of compounding the composition with a twin screw extruder.

72. The method of claim 68, further comprising the steps of providing a slot die having an outlet and providing apparatus downstream of the outlet for processing of the film.

73. The method of claim 68, wherein the thickness of the film formed is between about 0.75 and about 3 mils.

74. The method of claim 73, wherein the thickness is between about 1 and about 2 mils.

75. The method of claim 73, wherein the film has an Elmendorf tear value in the transverse direction of about 150 g/mil or less.

76. The method of claim 75, wherein the melt flow index of the composition selected is at least about 20 g/10 min.

77. The method of claim 73, wherein the film has an Elmendorf tear value in the transverse direction of about 100 g/mil or less.

78. The method of claim 77, wherein the melt flow index of the composition selected is at least about 40 g/10 min.

79. The method of claim 73, wherein the film has an Elmendorf tear value in the transverse direction of about 50 g/mil or less.

80. The method of claim 79, wherein the melt flow index of the composition selected is at least about 50 g/10 min.

81. The method of claim 68, further comprising the step of supplying a charge to the film.

82. The method of claim 81, wherein the charge is supplied by first and second charging stations wherein each of the stations supplies between about 10 to about 50 kilovolts and the film retains sufficient charge to develop at least approximately 1000 Volts/meter or more at three months or more following charging.

83. A method of producing a charged film, the method comprising the steps of:
forming a film from a composition;
placing first and second charging stations adjacent the film; and
charging the film with the first and second charging stations.

84. The method of claim 83, wherein the film is unstretched in the transverse direction.
